(19) United States
(12) Patent Application Publication
(10) Pub. No.: US 2015/0285135 A1
(43) Pub. Date: Oct. 8, 2015

(54) COMBUSTION ENGINE INCLUDING AN AIR INJECTOR, AND POWER GENERATING SYSTEM INCLUDING THE COMBUSTION ENGINE

(71) Applicant: Nexovation, Inc., Hendersonville, TN (US)

(72) Inventors: Robert Jay Sexton, Hendersonville, TN (US); Douglas L. Donsbach, Knoxville, TN (US)

(21) Appl. No.: 14/675,329

(22) Filed: Mar. 31, 2015

Related U.S. Application Data
(60) Provisional application No. 61/975,682, filed on Apr. 4, 2014.

(51) Int. Cl. F02B 47/06; F02B 21/00; F02M 35/10; F02M 61/14; F02B 75/02

(52) U.S. Cl. CPC F02B 47/06; F02M 61/14; F02B 75/02; F02M 35/1019; F02M 35/10091; F02B 21/00; F02B 2075/025

(57) ABSTRACT

A combustion engine includes a combustion cylinder, a fuel injector for injecting a fuel into the combustion cylinder, an oxygen source gas (OSG) injector for injecting compressed OSG into the combustion cylinder, and a piston which is formed in the cylinder and driven by force of a combustion reaction between the fuel and the compressed OSG.

### CROSS-REFERENCE TO RELATED APPLICATIONS

This Application claims priority to U.S. Provisional Patent Application No. 61/975,682, which was filed on Apr. 4, 2014, and is incorporated by reference herein.

### BACKGROUND OF THE INVENTION

1. Field of the Invention

The present invention relates to the field of the internal combustion engine. More specifically, the invention is a new generation of internal combustion engine that may increase efficiency and performance while reducing the number of engine components and complexity.

2. Description of Related Art

There are many known configurations of the internal combustion engine. Most of the engines in use today are of the four-cycle type used in automobiles and light trucks. These engines are called four-cycle engines because each piston in the engine completes four-cycles per power stroke. These four-cycles are the intake stroke, the compression stroke, the power stroke and the exhaust stroke.

The typical four-cycle engine consists of pistons connected to a crankshaft in such a way that rotation of the crankshaft causes the pistons to move up and down in a cylinder. At the top of the cylinder is a sealing cover called the cylinder head. Embedded in the cylinder head are one or more each intake valves and exhaust valves.

The intake and exhaust valves are opened and closed by the lobes on one or more camshafts synchronized to rotate at one half of the speed of the crankshaft (typically through the use of gears and or chains) in such a way that the intake valves are opened when the pistons move down on the intake stroke to allow a mixture of fuel and air to be drawn into the engine through an intake manifold attached to the cylinder head, both intake and exhaust valves are closed when the piston moves up on the compression stroke, both intake and exhaust valves remain closed as the mixture of fuel and air is ignited when the piston nears the top of the stroke and the resulting combustion process forces the piston down on the power stroke.

Finally, as the piston begins moving up again at the completion of the power stroke, the exhaust valves are opened to allow the spent combustion gasses to be forced out through an exhaust manifold attached to the cylinder head. The process repeats as long as the engine is running.

There are of course many variations on this scheme for the four-cycle engine, involving turbo- or supercharging the air into the intake manifold to increase the volume of the fuel and air charge that can be ingested by the cylinder during the intake stroke, thereby allowing more a more powerful combustion and increasing the power and or efficiency of the engine. There are also schemes in which the fuel is not mixed with the incoming air charge outside the cylinder head, but instead the fuel is directly injected into the cylinder as the piston nears the top of the compression stroke through a high-pressure fuel injector located in the cylinder head.

This approach has long been used for diesel fueled engines, but has been adopted over the last decade for use in some gasoline fueled engines. Finally, some implementations of the engine replace the mechanical camshafts that open and close the intake and exhaust valves with either hydraulic, pneumatic or electrical actuators, for example in applications for high performance racing engines.

There is also a class of internal combustion engines that use two-cycles instead of four-cycles per power stroke.

FIG. 1A illustrates an upstroke in a conventional two-cycle engine 100, and FIG. 1B illustrates a downstroke in the conventional two-cycle engine 100.

As illustrated in FIG. 1A, in an upstroke, the transfer port 110 is covered by the piston 115 in a cylinder 116, and the fuel mixture is drawn into the crankcase 120 via a valve 125. As the piston 115 rises, it compresses fuel at an upper portion 116a of the cylinder 116, and the fuel is ignited by a spark from the sparkplug 130 causing the fuel to combust which forces the piston 115 down.

As illustrated in FIG. 1B, in a downstroke, as the piston 115 is forced down by the combustion of the fuel, the valve 125 is closed and the piston 115 forces fuel out of the crankcase 120 and into the upper portion 116a of the cylinder 116 via the transfer port 110 which is not closed off by the piston 115. The fuel entering the upper portion 116a of the cylinder 116 forces burned fuel (i.e., exhaust) out of the exhaust port 135.

Two-cycle engines are used in applications where the complexity or size of the additional mechanical elements required to operate the valves is not suitable for the application. An example of the extremes of these applications is, at the small end of the size and power envelope, the model aircraft engine, and at the large end of the envelope, the marine diesel engine. In between are applications for leaf blowers, motorcycles, jet skis, snowmobiles, etc.

Two-cycle engines operate either by using ports in the side of the cylinder to act as valves as they are covered and uncovered by the piston as it cycles up and down, or by using an exhaust valve in a conventional cylinder head in conjunction with an intake port in the side of the cylinder. As in the case of the four-cycle engine, the exhaust valve in the latter case may be operated by either a conventional camshaft or by pneumatic, hydraulic or electric actuators.

The two-cycle engine functions by overlapping the exhaust and intake strokes in such a way that exhaust and intake strokes overlap with the compression stroke, in which the incoming intake charge serves to force the exhaust of the previous cycle out of the cylinder as the piston is completing the end of the power stroke. Note that in the case of the two-cycle engine with an exhaust valve in the cylinder head, the incoming air charge is typically pressurized with either a turbo- or supercharger in order to force the intake charge through the port in the side of the cylinder which has the effect of pushing the lighter and hotter exhaust gases up and out through the exhaust valve.

While it might seem that a two-cycle engine would offer superior efficiency and performance over a four-cycle engine, the overlapping of the intake and exhaust strokes in the two-cycle engine means that the combustion waste products are not removed as completely from the cylinder as in the four-cycle engine, resulting in inefficient combustion on the next cycle. Additionally, the time the intake port is open in the side of the cylinder is necessarily short, resulting in a generally smaller volume of fuel and air being injected into the engine.

Finally, because the piston is closer to the bottom of the stroke than the top of the stroke at the point that the intake charge enters the cylinder, a significant amount of energy is expended by both the conventional two and four-cycle engines in compressing the intake charge as the piston continues to the top of the stroke.

Both engines (e.g., four-cycle, two-cycle engines, etc.) may be designed to run on a variety of fuels. Everything from gasoline, to diesel, to biodiesel, to compressed natural gas (CNG) to hydrogen gas has been used to successfully run the internal combustion engine.

### SUMMARY

In view of the foregoing and other exemplary problems, disadvantages, and drawbacks of the aforementioned conventional systems and methods, an exemplary aspect of the present invention is directed to a combustion engine which may be more efficient and effective than conventional combustion engines.

An exemplary aspect of the present invention is directed to a combustion engine which includes a combustion cylinder, a fuel injector for injecting a fuel into the combustion cylinder, an oxygen source gas (OSG) injector for injecting compressed OSG into the combustion cylinder, and a piston which is formed in the cylinder and driven by force of a combustion reaction between the fuel and the compressed OSG.

Another exemplary aspect of the present invention is directed to a power generation system, including a fuel tank for storing a fuel, a pressurized oxygen source gas (OSG) tank for storing compressed OSG, and a combustion engine, including a combustion cylinder, a fuel injector for injecting the fuel into the combustion cylinder, an OSG injector for injecting the compressed OSG into the combustion cylinder, and a piston which is formed in the combustion cylinder and driven by force of a combustion reaction between the fuel and the compressed OSG.

Another exemplary aspect of the present invention is directed to a method of generating power, including injecting a fuel into a combustion cylinder, injecting compressed OSG into the combustion cylinder, and driving a piston in the combustion cylinder by force of a combustion reaction between the fuel and the compressed OSG.

With its unique and novel features, the present invention may provide a combustion engine which is more efficient and effective than conventional combustion engines.

### BRIEF DESCRIPTION OF THE DRAWINGS

The foregoing and other exemplary purposes, aspects and advantages will be better understood from the following detailed description of the embodiments of the invention with reference to the drawings, in which:

FIG. 1A illustrates an upstroke in a conventional two-cycle engine 100;

FIG. 1B illustrates a downstroke in the conventional two-cycle engine 100;

FIG. 2A illustrates an upstroke in an engine 200, according to an exemplary aspect of the present invention;

FIG. 2B illustrates a downstroke in the engine 200, according to an exemplary aspect of the present invention;

FIG. 3A illustrates a first exemplary flow rate of OSG into the cylinder 216 according to an exemplary aspect of the present invention;

FIG. 3B illustrates a second exemplary flow rate of OSG into the cylinder 216 according to another exemplary aspect of the present invention;

FIG. 3C illustrates a third exemplary flow rate of OSG into the cylinder 216 according to another exemplary aspect of the present invention;

FIG. 4 illustrates a power generating system 400 including an engine 450, according to another exemplary aspect of the present invention;

FIG. 5 illustrates a power generating system 500 including an engine 450, according to another exemplary aspect of the present invention;

FIG. 6 illustrates a power generating system 600 including an engine 450, according to another exemplary aspect of the present invention;

FIG. 7 illustrates a power generating system 700 including an engine 450, according to another exemplary aspect of the present invention;

FIG. 8 illustrates a power generating system 800 including an engine 450, according to another exemplary aspect of the present invention;

FIG. 9 illustrates a method of generating power 600, according to an exemplary aspect of the present invention;

FIG. 10 illustrates a power generating system 1000, according to an exemplary aspect of the present invention;

FIG. 11 illustrates a power generating system 1100, according to an exemplary aspect of the present invention; and

FIG. 12 illustrates a power generating system 1200, according to an exemplary aspect of the present invention;

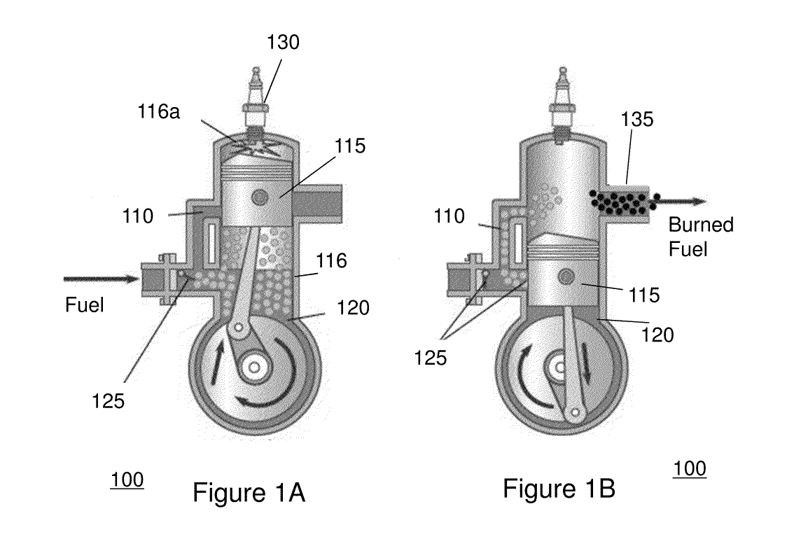

### DETAILED DESCRIPTION OF EXEMPLARY EMBODIMENTS OF THE INVENTION

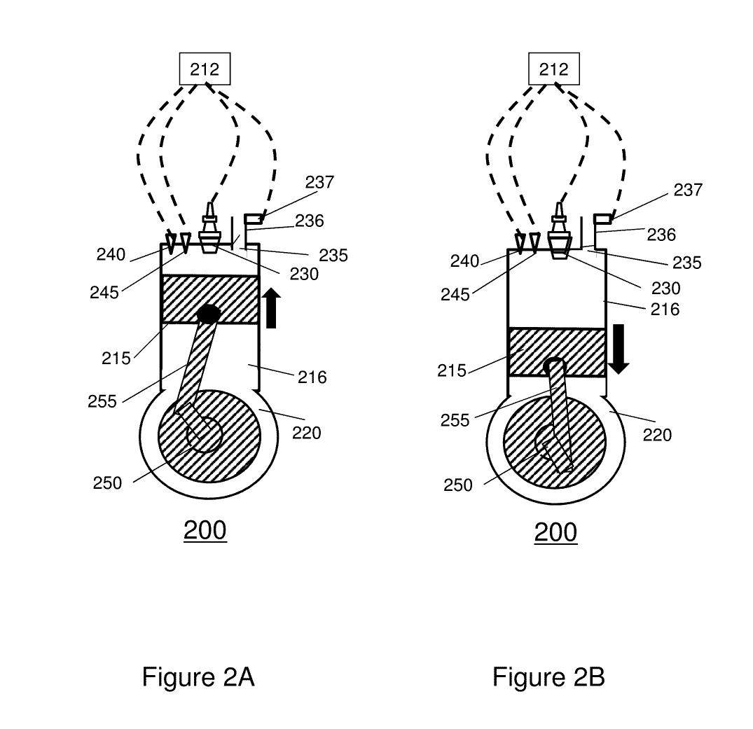

Referring now to the drawings, FIGS. 2A-12 illustrate some of the exemplary aspects of the present invention.

An exemplary aspect of the present invention is directed to a system that may increase the efficiency and performance of the internal combustion engine. The system may supply a compressed fuel and oxygen source gas (OSG) such as air to the internal combustion engine without the need for an intake piston stroke, as in the case of the four-cycle engine, and without the energy-wasting compression stroke as in the case for both two and four-cycle engines. Unless otherwise specified herein, the term “oxygen source gas” or “OSG” should be construed to mean any oxygen-containing gas (e.g., air, pure oxygen, oxygen-rich air, etc.) that may be react with the fuel to cause a combustion reaction in an engine cylinder.

The system may be able to use multiple fuel types for the operation of an internal combustion engine. It should be noted that the term “fuel” herein should be construed to mean CNG, gasoline, diesel fuel, biodiesel fuel, alcohol (e.g., ethyl alcohol), jet fuel, compressed hydrogen gas, or any other gaseous or liquid fuel (e.g., compressed combusticle fuel) that can be used in an internal combustion engine.

The system may supply the compressed fuel and OSG to the internal combustion engine without the need for an overlapped exhaust/intake piston stroke, as in the case of a conventional two-cycle engine. The system may provide one power stroke per two-cycles of the piston without using a cylinder port for the intake charge. The system may provide one power stroke per two-cycles of the piston while allowing the waste products of the combustion process to be completely exhausted from the cylinder. The system may also provide for the ability to start the internal combustion engine, without the need for an external electrical starter motor.

In the exemplary aspects of the present invention, a fuel may be used in conjunction with the OSG (e.g., compressed air) to provide the fuel and OSG to an internal combustion engine. The exemplary aspects of the present invention may replace the conventional intake valve as used on an internal combustion engine to deliver increased power and efficiency. The internal combustion engine may then be used in global transportation and power generation applications.

### First Embodiment

FIG. 2A illustrates an upstroke in an engine 200, according to an exemplary aspect of the present invention, and FIG. 2B illustrates a downstroke in the engine 200, according to an exemplary aspect of the present invention.

As illustrated in FIGS. 2A and 2B, the engine 200 includes a combustion engine including a combustion cylinder 216, a fuel injector 240 for injecting a fuel into the combustion cylinder 216, an oxygen source gas (OSG) injector 245 for injecting compressed OSG into the combustion cylinder 216, and a piston 215 which is formed in the combustion cylinder 216 and is driven by force of a combustion reaction between the fuel and the compressed OSG.

In particular, the engine 200 includes the cylinder 216 (e.g., a plurality of cylinders), the piston 215 formed in the cylinder 216 and connected by a connecting rod 255 to a crankshaft 250 in a crankcase 220. The engine 200 also includes the fuel injector 240 (e.g., fuel valve) for injecting a fuel into the cylinder 216. The fuel injector 240 may include, for example, a valve which is manipulated (e.g., opened, closed, partially opened) to allow compressed gaseous fuel to enter the cylinder 216.

The engine 200 also includes the OSG injector 245 (e.g., OSG valve) for injecting OSG (e.g., compressed air) into the cylinder 216. The OSG injector 245 may include, for example, a valve which is manipulated (e.g., opened, closed, partially opened) to allow compressed gaseous fuel to enter the cylinder 216.

It should be noted that although FIGS. 2A and 2B illustrate the engine 200 having only one fuel injector 240 and one OSG injector 245, the engine 200 may include a plurality of fuel injectors 240 and/or a plurality of OSG injectors 245. In addition, the fuel injector 240 and OSG injector 245 may be placed on the head of the cylinder 216 and on one side of the sparkplug 230, (as illustrated in FIGS. 2A and 2B), or may be alternatively be placed on a side of the cylinder 216, or on opposing sides of the sparkplug 230. In particular, the number and placement of the fuel injectors 240 and the OSG injectors 245 may be set so as to maximize the efficiency of the engine 200 (e.g., horsepower generated per unit of fuel) and/or to minimize the amount of pollutants in the combustion product.

The engine 200 also includes an exhaust valve 235 for exhausting the combustion product (e.g., a product of the combustion reaction between the fuel and the OSG) from the cylinder 216, and an exhaust line 236 formed on the cylinder 216 over the exhaust valve 235 for transporting the combustion product away from the cylinder 216.

The engine 200 also includes a sensor 237 which may be formed, for example, in the exhaust line 236, and detects a component and/or an amount of a component of the gases in the exhaust line 236 (e.g., a component in the combustion product). For example, the sensor 237 may detect an amount of fuel in the combustion product which may reveal how efficiently the engine 200 is operating. The sensor 237 may also detect an amount of OSG in the combustion product, which may indicate that the OSG injector 245 is injecting OSG too soon in the upstroke (e.g., if the amount of OSG in the combustion product is above a predetermined concentration), or that the OSG injector 245 is injecting OSG too late in the upstroke (e.g., if the amount of OSG in the combustion product is below a predetermined concentration).

The sensor 230 may also be coupled to a controller 212 (e.g., microcontroller, microprocessor, central processing unit, vehicle electronic control unit (ECU), etc.) which controls an operation of the engine 200. For example, the controller 212 may be coupled to the fuel injector 240 to control an operation (e.g., timing, pressure, quantity injected) of the fuel injector 240, the OSG injector 245 to control an operation (e.g., timing, pressure, quantity injected) of the OSG injector 245, and the sparkplug 230 to control an operation (e.g., timing, quantity of spark) of the sparkplug.

As illustrated in FIG. 2A, in the upstroke, the exhaust valve 235 is open and the rising of the piston (e.g., in a direction away from the crankcase 220) forces the combustion product out of the cylinder 216 via the exhaust valve 235.

In one particular embodiment, after piston 215 has completed the upstroke (e.g., after the piston 215 has at least substantially reached its uppermost point in the cylinder 216), with the exhaust valve 235 still open, the OSG injector 245 injects OSG into the cylinder 216 which forces any remaining combustion product out of the cylinder 216 via the valve 235. After a short period (e.g., a few milliseconds after the OSG is injected into the cylinder 216), the valve 235 is closed and the fuel injector 240 injects fuel into the cylinder 216, where the fuel is mixed with the OSG under pressure. After the fuel has stopped being injected by the fuel injector 240, the sparkplug 230 may ignite to initiate the combustion reaction, which forces the piston 215 down (e.g., in a direction toward the crankcase 220).

As illustrated in FIG. 2B, in the downstroke, the valve 235 is closed and the energy from the combustion reaction in the cylinder 216 is used to force the piston 215 down toward the crankcase 220, causing a rotational force on the crankshaft 250 via the connecting rod 255.

An important aspect of the present invention is control of: 1) a timing of the injection of OSG by the OSG injector 245, 2) a timing of the injection of the fuel by the fuel injector 240, and 3) a timing of the ignition by the sparkplug 230. Another important aspect of the present invention is control of: 1) the quantity of OSG injected (e.g., flow rate (cm³/sec) of OSG entering the cylinder 216 via the OSG injector 245, 2) the quantity of fuel injected (e.g., flow rate (cm³/sec) of fuel entering the cylinder 216 via the fuel injector 240 and 3) quantity of spark from the sparkplug 230. In the present invention, these conditions may be controlled so as to maximize the efficiency of the engine 200 (e.g., horsepower generated per unit of fuel) and/or to minimize the amount of pollutants in the combustion product.

In particular, the sensor 237 may transmit to the controller 212 an exhaust detection signal which indicates that a condition in the exhaust line 236, such as a concentration of a component in the combustion product and/or a concentration of OSG in the exhaust line. Based on the exhaust detection signal, the controller 212 may set the timing and/or quantity of the injection of OSG, the timing and/or quantity of the injection of the fuel, and the timing and/or quantity of spark.

Alternatively, the controller 212 may set the timing and/or quantity of the injection of OSG, the timing and/or quantity of the injection of the fuel, and the timing and/or quantity of spark based on other signals (i.e., based on other data or signals received by the controller 212).

For example, the timing of the spark may alternatively (or in addition to the exhaust detection signal) be based on a ratio of fuel to OSG in the cylinder 216. This ratio may be calculated, for example, by the controller 212 which may receive an oxygen concentration signal from an oxygen sensor located in the OSG tank or in the OSG line from the OSG tank to the engine. Thus, for example, the timing of the ignition by the sparkplug 230 may depend upon the concentration of oxygen in the OSG. For example, for a first concentration of oxygen in the OSG, the controller 212 may set the timing of the spark to occur at a first timing, and for a second concentration of oxygen in the OSG which is greater than the first concentration of oxygen, the controller 212 may set the timing of the spark to occur at a second timing which is earlier than the first timing.

Alternatively, the oxygen concentration signal may be transmitted to the controller 212 manually by a user (e.g., a user of a vehicle in which the engine operates). For example, the vehicle may include a switch which may be set by the user to indicate whether the OSG tank contains compressed air or pure oxygen, and the switch may generate the oxygen concentration signal which is used by the controller 212 to set the timing of the spark by the sparkplug 230.

The timing of the spark may alternatively (or in addition to the exhaust detection signal and/or in addition to the oxygen concentration signal) be based on a type of fuel (e.g., CNG, compressed hydrogen, etc.) being used in the engine 200. The type of fuel may be detected, for example, by a sensor located in a fuel tank of a vehicle in which the engine 200 operates, or in the fuel line from the fuel tank to the engine 200. The sensor may generate a fuel type signal which is transmitted to the controller 212 which set the timing of the spark of the sparkplug 230 based on the fuel type signal. Thus, for example, the timing of the ignition by the sparkplug 230 may depend upon the fuel type being used in the engine.

It should be noted that, as with the timing of the spark, the controller 212 may also set the timing and/or quantity of the injection of OSG, the timing and/or quantity of the injection of the fuel, and the quantity of spark based on the oxygen concentration signal and/or the fuel type signal. The controller 212 may also coordinate all of these conditions (e.g., the timing and/or quantity of the injection of OSG, the timing and/or quantity of the injection of the fuel, and the timing and/or quantity of spark) in order to maximize the efficiency of the engine 200 (e.g., horsepower generated per unit of fuel) and/or to minimize the amount of pollutants in the combustion product.

It should also be noted that the OSG injector 245 may stop injecting OSG at the same time that the fuel injector 240 stops injecting fuel into the cylinder 216 (i.e., prior to the spark by the sparkplug 230). Alternatively, the OSG injector 245 may continue to inject OSG into the cylinder 216 after the spark by the sparkplug 230 which may help to force the piston 215 down, and may help to force the combustion product out of the cylinder during the subsequent upstroke. As another alternative, the OSG injector 245 may continue to inject OSG into the cylinder 216 after the spark by the sparkplug 230, but at a reduced level. That is, the OSG injector 245 may inject OSG into the cylinder 216 at a first flow rate at a time when the piston 215 is at the end of the upstroke, and may inject OSG into the cylinder 215 at a second flow rate less than the first flow rate, after the spark by the sparkplug 230.

Thus, the OSG injector 245 may include a variable flow rate valve (flow-control valve) that is able to vary the flow rate (or pressure) of OSG. The variable flow rate valve may respond, for example to a signal generated by an independent device such as a flow meter (e.g., a flow meter in the OSG supply line). To control the flow rate, the variable flow rate valve may be fitted, for example, with an actuator (e.g., pneumatic actuator) or positioner. For example, the variable flow-rate valve may include a pneumatically-actuated globe valve, diaphram valve, ball valve, gate valve or butterfly valve.

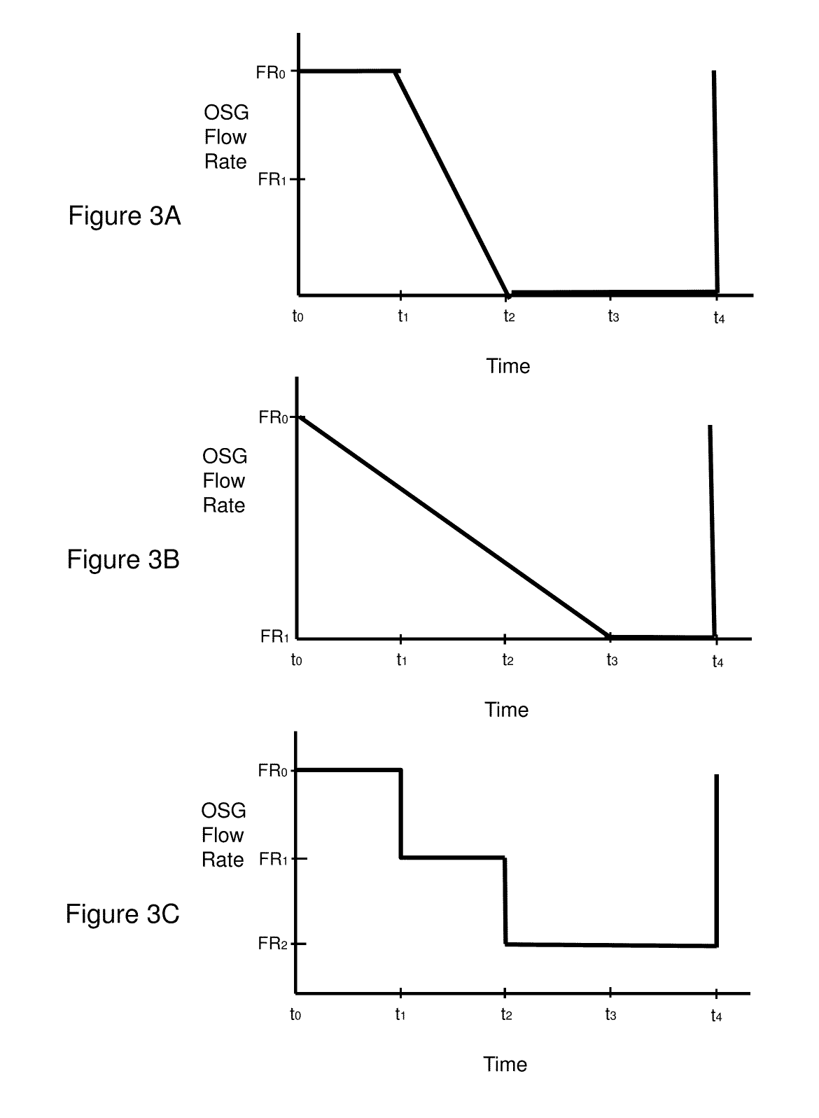

FIGS. 3A-3C illustrate how the flow rate of OSG supplied by the OSG injector 245 may vary depending upon the stage (e.g., upstroke, downstroke, etc.) in which the engine is operating. In FIGS. 3A-3C, the time t₀ is the time at which the piston 215 ends the upstroke, time t₁ is the time that the combustion product (e.g., exhaust gas) has been removed (e.g., substantially removed) from the cylinder 216 (e.g., forced out of the cylinder 216 by the OSG), and the time that the fuel injector begins injecting fuel into the cylinder 216, time t₂ is the time of the spark from the sparkplug 230 and the beginning of the downstroke by the piston 215, time t₃ is the time that the downstroke is completed and the piston 215 begins the next upstroke, and time t₄ is the end of the next upstroke (i.e., t₃=t₀).

FIG. 3A illustrates a first exemplary flow rate of OSG into the cylinder 216 according to an exemplary aspect of the present invention. As illustrated in FIG. 3A, the flow rate is initially at FR₀ at t₀ and remains constant at FR₀ from t₀ to t₁, and then decreases (e.g., continuously decreases) from t₁ to t₂ at which time the flow rate of OSG is zero. The flow rate remains at zero from t₂ to t₄ at which time the flow rate returns to FR₀.

FIG. 3B illustrates a second exemplary flow rate of OSG into the cylinder 216 according to another exemplary aspect of the present invention. As illustrated in FIG. 3B, the flow rate is initially at FR₀ at t₀, but decreases (e.g., continuously decreases) from t₀ to t₃ at which time the flow rate of OSG is zero. The flow rate remains at zero from t₃ to t₄ at which time the flow rate returns to FR₀.

FIG. 3C illustrates a third exemplary flow rate of OSG into the cylinder 216 according to another exemplary aspect of the present invention. As illustrated in FIG. 3C, the flow rate is initially at FR₀ at t₀, and remains constant at FR₀ from t₀ and t₁ at which time the flow rate decreases to FR₁. The flow rate remains constant at FR₁ from t₁ to t₂ at which time the flow rate decreases to FR₂. The flow rate remains at FR₂ from t₂ to t₄ at which time the flow rate returns to FR₀. Thus, in this exemplary embodiment, the OSG injector 245 continually feeds OSG to the cylinder 216 (e.g., throughout the entire engine cycle (e.g., both upstroke and downstroke)).

It should be noted that FIGS. 3A-3C are not intended to be limiting, but are simply intended to be illustrative of the manner in which the OSG injector 245 may vary the flow rate of OSG into the cylinder 216. Other manners of varying the flow rate of OSG are possible in addition to those illustrated in FIGS. 3A-3C.

In addition, the manner in which the engine 200 varies the flow rate of OSG into the cylinder may vary depending upon various factors, such as a property of the OSG, a property of the fuel, a property of the combustion product detected by sensor 237, the ambient temperature, the speed of the vehicle, the temperature of the engine coolant, and so on. Thus, for example, if the ambient temperature is 90° F. the engine 200 may operate according to FIG. 3A, but if the ambient temperature is 10° F. the engine 200 may operate according to FIG. 3B, and so on. Further, the controller 212 may select an OSG flow rate from among a plurality of OSG flow rates (e.g., from among the flow rates of FIGS. 3A-3C which are stored in a memory device accessible by the controller 212) in order to maximize the efficiency of the engine 200 (e.g., horsepower generated per unit of fuel) and/or to minimize the amount of pollutants in the combustion product.

The engine 200 has several benefits over conventional four-cycle engines and two-cycle engines. Compared to a four-cycle engine, the present invention does not require a separate stroke for intake and a separate stroke for exhaust. Therefore, the present invention provides a power stroke every two strokes as opposed to the four strokes required in a four-cycle engine.

Compared to a conventional two-cycle engine, the present invention provides at least four benefits. First, in the present invention, the fuel is not injected into the crankcase and therefore, the fuel does not need to include a lubricant which decreases the combustibility (e.g., energy of combustion) of the fuel mixture in a conventional two-cycle engine. Second, the present invention is more efficient than a conventional two-cycle engine on the upstroke because in the present invention energy is not lost in compressing the fuel/OSG mixture. That is, in the present invention, the piston 215 may rise with much less resistance as compared to a conventional two-cycle engine.

Third, the present invention is more efficient than a conventional two-cycle engine on the downstroke because in the present invention energy is not lost in forcing the fuel mixture into the upper portion of the cylinder 216 through a transfer port, as in the conventional two-cycle engine. That is, in the present invention, the combustion of the fuel may force the piston 215 down with much less resistance as compared to a conventional two-cycle engine. Fourth, the present invention does require a supercharger or turbocharger to force air into the cylinder 216 (although the present invention does not necessarily preclude the additional use of a supercharger or turbocharger) and, therefore, is more efficient and less costly than conventional two-cycle engine.

### Second Embodiment

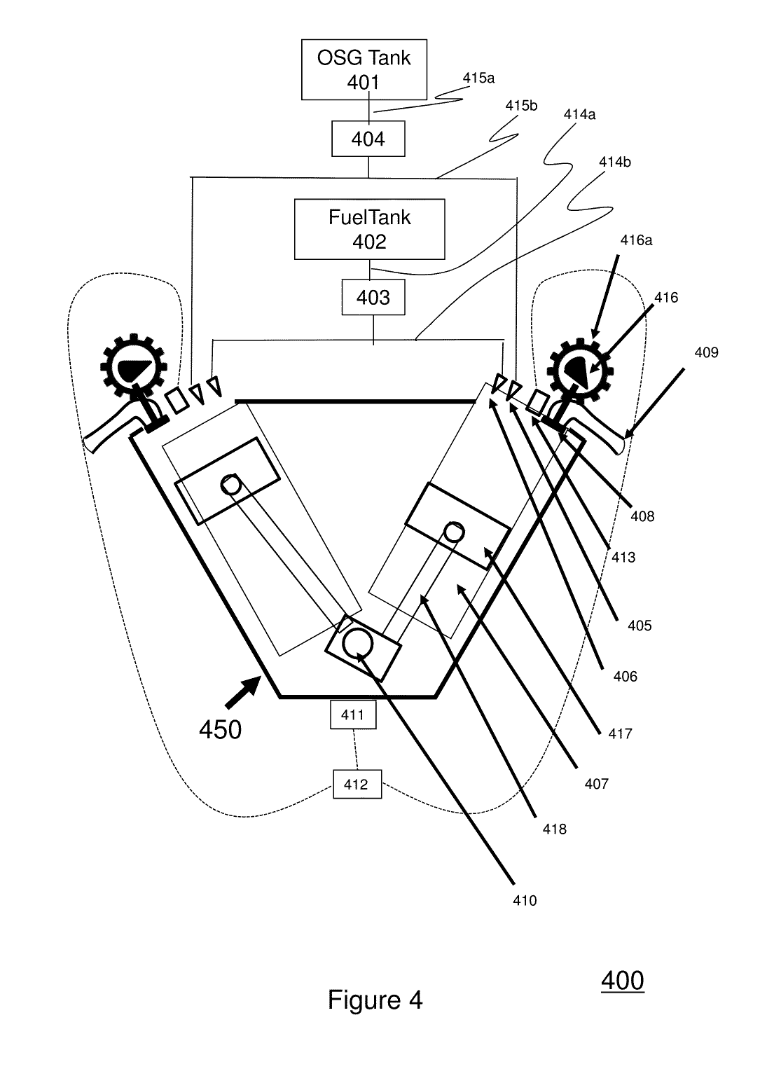

FIG. 4 illustrates a power generating system 400 including an engine 450, according to another exemplary aspect of the present invention. The descriptions above with respect to the first embodiment are incorporated herein by reference.

In particular, FIG. 4 illustrates an exemplary schematic block diagram of a CNG powered engine, utilizing OSG (e.g., compressed air) to mix with the CNG fuel to promote combustion. FIG. 4 also illustrates an exemplary engine start system utilizing the properties of the OSG and CNG.

As illustrated in FIG. 4, the fuel (e.g., CNG fuel) is routed from a fuel tank 402 (e.g., high pressure fuel tank), to the fuel expansion valve 403 via a first fuel line 414a. The fuel expansion valve 403 reduces the pressure of the fuel and allows the second fuel line 414b to route the reduced pressure fuel to a fuel injector 406.

OSG (e.g., air) is routed from a high pressure OSG tank 401, to the OSG expansion valve 404 via a first OSG line 415a. The OSG expansion valve 404 reduces the pressure of the OSG and allows the second OSG line 415b to route the reduced pressure OSG to an OSG injector 405.

Reduced pressure OSG from OSG injector 405 and reduced pressure fuel from fuel injector 406 are mixed in the cylinder 407 and ignited by igniter 413 (e.g., sparkplug) to produce combustion and rapid expansion of the combined OSG and fuel mixture to drive the piston 417 down and rotate the crankshaft 410 through the connecting rod 418.

A camshaft 416 is directly driven by the crankshaft 410 through a gear 416a so that the camshaft 416 makes one revolution for each revolution of the crankshaft 410. A camshaft lobe on the camshaft 416 operates an exhaust valve 408 so that as the piston 417 reaches the end of the downward travel, the camshaft lobe opens the exhaust valve 408 so that as the piston 417 reverses its direction due to the connecting rod 418 and moves up in the cylinder 407, the spent combustion gasses may be forced from the cylinder 407 by the piston 417 out through the exhaust valve 408 to the connected exhaust manifold 409.

As the crankshaft 410 continues to rotate, the camshaft 416 also continues to rotate and the camshaft lobe allows the exhaust valve 408 to close, sealing the cylinder 407.

A computerized controller 412 (e.g., electronic control unit (ECU)) monitors the rotation of the crankshaft 410 through crankshaft position sensor 411. As the crankshaft position sensor 411 indicates the crankshaft 410 has positioned the piston 417, through the connecting rod 418, very near the top of the cylinder 407, the computerized controller 412 opens the OSG injector 405 and the fuel injector 406 to charge the cylinder 407 with an optimum mixture of OSG and fuel and the computerized controller 412 ignites the OSG and fuel mixture using the igniter 413, and another cycle begins.

It should be noted that noted that the computerized controller 412 may also control the fuel injector 406, OSG injector 405 and igniter 413 in a manner discussed above with respect to FIGS. 2A-3C.

In particular, the computerized controller 412 may optionally introduce the OSG and/or fuel charge through the OSG injector 405 and the fuel injector 406 earlier in the cycle based on several factors, including but not limited to the pressure of the OSG and/or fuel in the secondary OSG line 415b and secondary fuel line 414b. For example, it might be desirable to have a partial compression of the OSG charge provided by the OSG expansion valve 404, with the remainder of the compression provided by the piston 417 as it moves upward in the cylinder. Additionally, the earlier introduction of the OSG charge may be useful to function as a partial purge of the combustion gases from the cylinder.

The computerized controller 412 may include a memory device (e.g., random access memory (RAM), read-only memory (ROM), non-volatile state memory, etc.) that stores data to be used by the controller 412 to control an operation in the power generating system 400. In particular, the computerized controller may store information on a position of the crankshaft position sensor 411, and thus the position of the piston 417 when the power generating system 400 is not operating.

Such information stored in the memory device of the computerized controller 412 can be used by the computerized controller 412 to identify which cylinder in the engine has a closed exhaust valve 408 (e.g., which cylinder of the engine has a piston positioned at the end of the upstroke). If the power generating system 400 is in the “OFF” state and a user turns on the ignition switch (e.g., pushes the “ON” button), then the computerized controller 412 may refer to the memory device to identify the cylinder having a closed exhaust valve 408, and then use that identified cylinder as a mechanism for starting the engine.

In particular, the computerized controller 412 may introduce an OSG and fuel charge into the identified cylinder 407 through OSG injector 405 and fuel injector 406, and ignite the OSG and fuel mixture using the igniter 413, thus forcing the piston 417 down in the identified cylinder 407, and starting a rotation of the crankshaft 410 through the connecting rod 418. After starting the rotation of the crankshaft 410, the power generating system 400 may proceed with the normal operation of the other cylinders in the power generating system 400.

In this way the exemplary implementation of power generating system 400 may allow the engine to be started without using an external electric starter motor.

### Third Embodiment

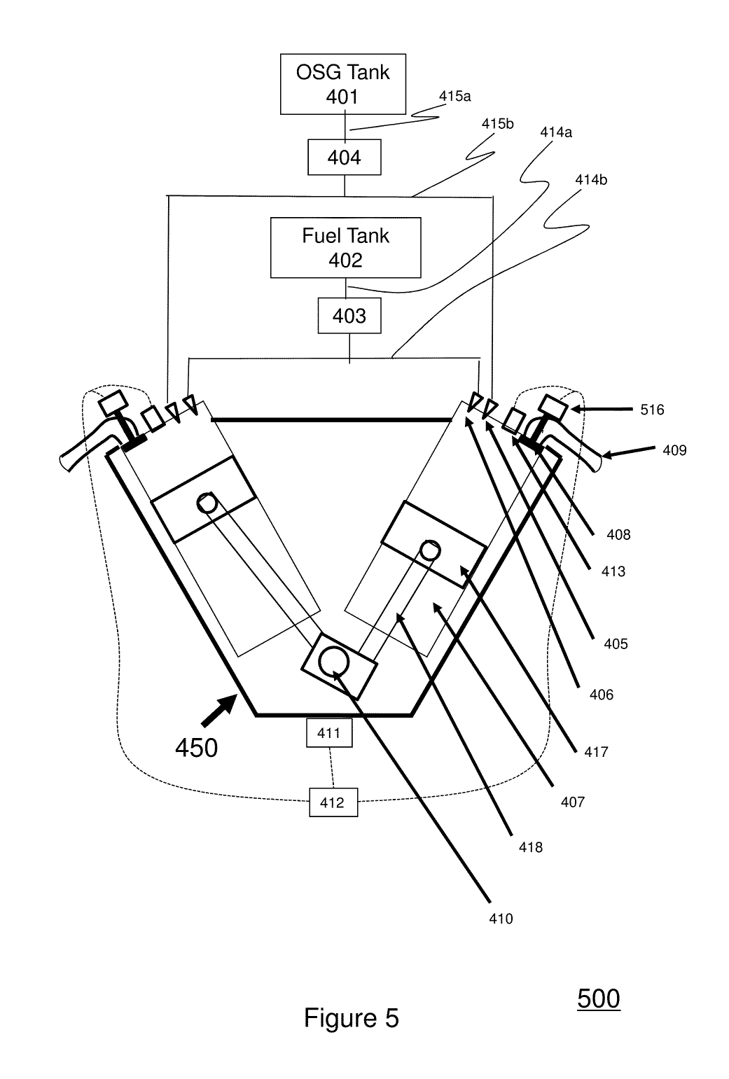

FIG. 5 illustrates a power generating system 500 including an engine 450, according to an exemplary aspect of the invention. The descriptions above with respect to the first and second embodiments are incorporated herein by reference.

In particular, FIG. 5 illustrates an exemplary schematic block diagram of a CNG powered engine, utilizing a source of compressed OSG to mix with the CNG fuel to promote combustion. FIG. 5 also illustrates an exemplary engine start system utilizing the properties of the compressed OSG and CNG, as well as replacement of the camshaft with an exhaust valve actuator (electrical, pneumatic or hydraulic) that can be used to control the opening and closing of the exhaust valve 408.

As illustrated in FIG. 5, the CNG fuel is routed from a fuel tank 402, to the fuel expansion valve 403 via a first fuel line 414a. The fuel expansion valve 403 reduces the pressure of the fuel and allows the second fuel line 414b to route the reduced pressure fuel to a fuel injector 406.

OSG is routed from a high pressure OSG tank 401, to the OSG expansion valve 404 via a first OSG line 415a. The OSG expansion valve 404 reduces the pressure of the OSG and allows the second OSG line 415b to route the reduced pressure OSG to an OSG injector 405.

Reduced pressure OSG from OSG injector 405 and reduced pressure fuel from fuel injector 406 are mixed in the cylinder 407 and ignited by igniter 413 to produce combustion and rapid expansion of the combined OSG and fuel mixture to drive the piston 417 down and rotate the crankshaft 410 through the connecting rod 418.

A computerized controller 412 monitors the rotation of the crankshaft 410 through the crankshaft position sensor 411 and activates an exhaust valve actuator 516 that uses either electrical, pneumatic or hydraulic energy to operate an exhaust valve 408 so that as the piston 417 reaches the end of the downward travel, the exhaust valve actuator 516 opens the exhaust valve 408 so that as the piston 417 reverses its direction due to the connecting rod 418 and moves up in the cylinder 407, the spent combustion gasses are forced from the cylinder 407 by the piston 417 out through the exhaust valve 408 to the connected exhaust manifold 409.

As the crankshaft 410 continues to rotate, the computerized controller 412 also continues to monitor the rotation of the crankshaft 410 through the crankshaft position sensor 411. As the crankshaft position sensor 411 indicates the crankshaft 410 has positioned the piston 417, through the connecting rod 418, near the top of the cylinder 407 the computerized controller deactivates the exhaust valve actuator 516 and allows the exhaust valve 408 to close, sealing the cylinder 407.

As the crankshaft position sensor 411 indicates the crankshaft 410 has positioned the piston 417, through the connecting rod 418, very near the top of the cylinder 407, the computerized controller 412 opens the OSG injector 405 and the fuel injector 406 to charge the cylinder 407 with an optimum mixture of OSG and fuel and the computerized controller 412 ignites the OSG and fuel mixture using the igniter 413, and another cycle begins.

It should be noted that noted that the computerized controller 412 may also control the fuel injector 406, OSG injector 405 and igniter 413 in a manner discussed above with respect to FIGS. 2A-3C.

The computerized controller 412 has non-volatile state memory that is able to know the position of the crankshaft position sensor 411, and thus the position of the piston 417 when the power generating system 500 is not operating. This can be used as an exemplary starting mechanism by determining if the position of the crankshaft 410 has positioned the piston 417, through the connecting rod 418 on the downward stroke. If the piston 417 is on the downward stroke, the computerized controller 412 is able to, through the exhaust valve actuator 516, close the exhaust valve 408 and introduce an OSG and fuel charge into the cylinder 407 through OSG injector 405 and fuel injector 406 and ignite the OSG and fuel mixture using the igniter 413, thus forcing the piston 417 down and starting rotation of the crankshaft 410 through the connecting rod 418. In this way the exemplary implementation of power generating system 200 allows the engine to be started without using an external electric starter motor.

### Fourth Embodiment

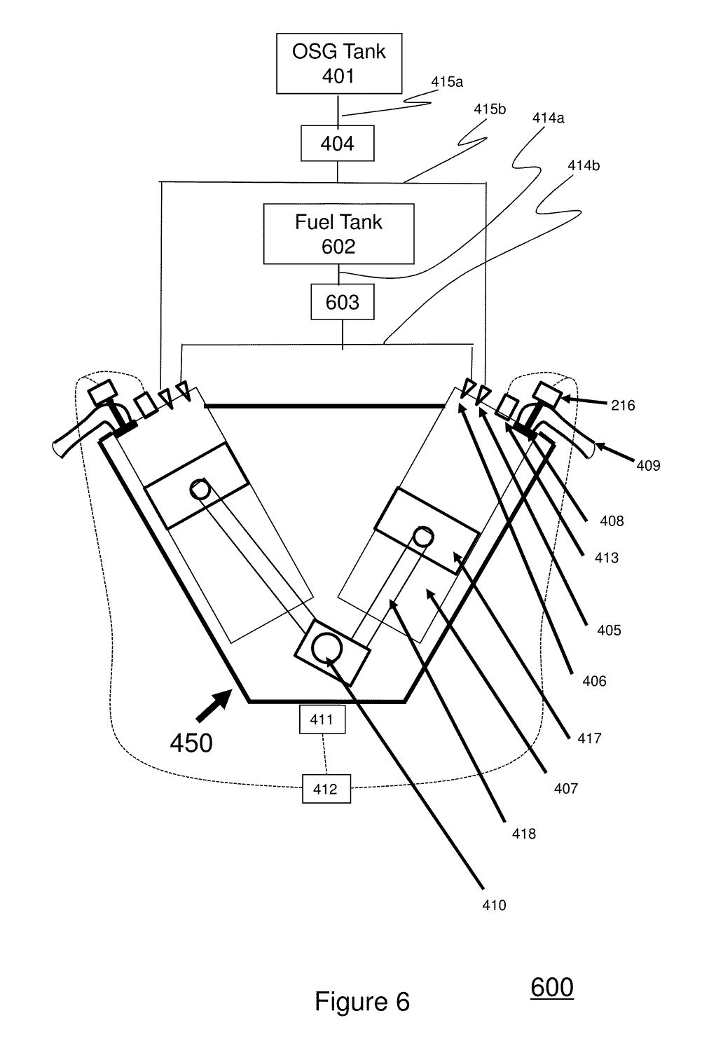

FIG. 6 illustrates a power generating system 600 including an engine 450, according to an exemplary aspect of the invention. The descriptions above with respect to the first through third embodiments are incorporated herein by reference.

In particular, FIG. 6 illustrates an exemplary schematic block diagram of a diesel or gasoline powered engine, utilizing a source of compressed OSG to mix with the diesel or gasoline fuel to promote combustion. FIG. 6 also illustrates an exemplary engine start system utilizing the properties of the compressed OSG and diesel or gasoline fuel.

As illustrated in FIG. 6, the diesel or gasoline fuel is routed from a tank 602, which is under atmospheric pressure, to the fuel pressure pump 603 via a first fuel line 414a. The fuel pressure pump 603 increases the pressure of the fuel and allows the second fuel line 414b to route the high pressure fuel to a fuel injector 406.

OSG is routed from a high pressure OSG tank 401, to the OSG expansion valve 404 via a first OSG line 415a. The OSG expansion valve 404 reduces the pressure of the OSG and allows the second OSG line 415b to route the reduced pressure OSG to an OSG injector 405.

Reduced pressure OSG from OSG injector 405 and pressurized fuel from fuel injector 406 (via the fuel pump 603) are mixed in the cylinder 407 and ignited by igniter 413 to produce combustion and rapid expansion of the combined OSG and fuel mixture to drive the piston 417 down and rotate the crankshaft 410 through the connecting rod 418.

A computerized controller 412 monitors the rotation of the crankshaft 410 through the crankshaft position sensor 411 and activates an exhaust valve actuator 516 that uses either electrical, pneumatic or hydraulic energy to operate an exhaust valve 408 so that as the piston 417 reaches the end of the downward travel, the exhaust valve actuator 516 opens the exhaust valve 408 so that as the piston 417 reverses its direction due to the connecting rod 418 and moves up in the cylinder 407, the spent combustion gasses are forced from the cylinder 407 by the piston 417 out through the exhaust valve 408 to the connected exhaust manifold 409.

As the crankshaft 410 continues to rotate, the computerized controller 412 also continues to monitor the rotation of the crankshaft 410 through the crankshaft position sensor 411. As the crankshaft position sensor 411 indicates the crankshaft 410 has positioned the piston 417, through the connecting rod 418, near the top of the cylinder 407 the computerized controller deactivates the exhaust valve actuator 516 and allows the exhaust valve 408 to close, sealing the cylinder 407.

As the crankshaft position sensor 411 indicates the crankshaft 410 has positioned the piston 417, through the connecting rod 418, very near the top of the cylinder 407, the computerized controller 412 opens the OSG injector 405 and the fuel injector 406 to charge the cylinder 407 with an optimum mixture of OSG and fuel and the computerized controller 412 ignites the OSG and fuel mixture using the igniter 413, and another cycle begins.

It should be noted that noted that the computerized controller 412 may also control the fuel injector 406, OSG injector 405 and igniter 413 in a manner discussed above with respect to FIGS. 2A-3C.

The computerized controller 412 has non-volatile state memory that is able to know the position of the crankshaft position sensor 411, and thus the position of the piston 417 when the power generating system 600 is not operating. This can be used as an exemplary starting mechanism by determining if the position of the crankshaft 410 has positioned the piston 417, through the connecting rod 418 on the downward stroke. If the piston 417 is on the downward stroke, the computerized controller 412 is able to, through the exhaust valve actuator 516, close the exhaust valve 408 and introduce an OSG and fuel charge into the cylinder 407 through OSG injector 405 and fuel injector 406 and ignite the OSG and fuel mixture using the igniter 413, thus forcing the piston 417 down and starting rotation of the crankshaft 410 through the connecting rod 418. In this way the exemplary implementation of power generating system 600 allows the engine to be started without using an external electric starter motor.

### Fifth Embodiment

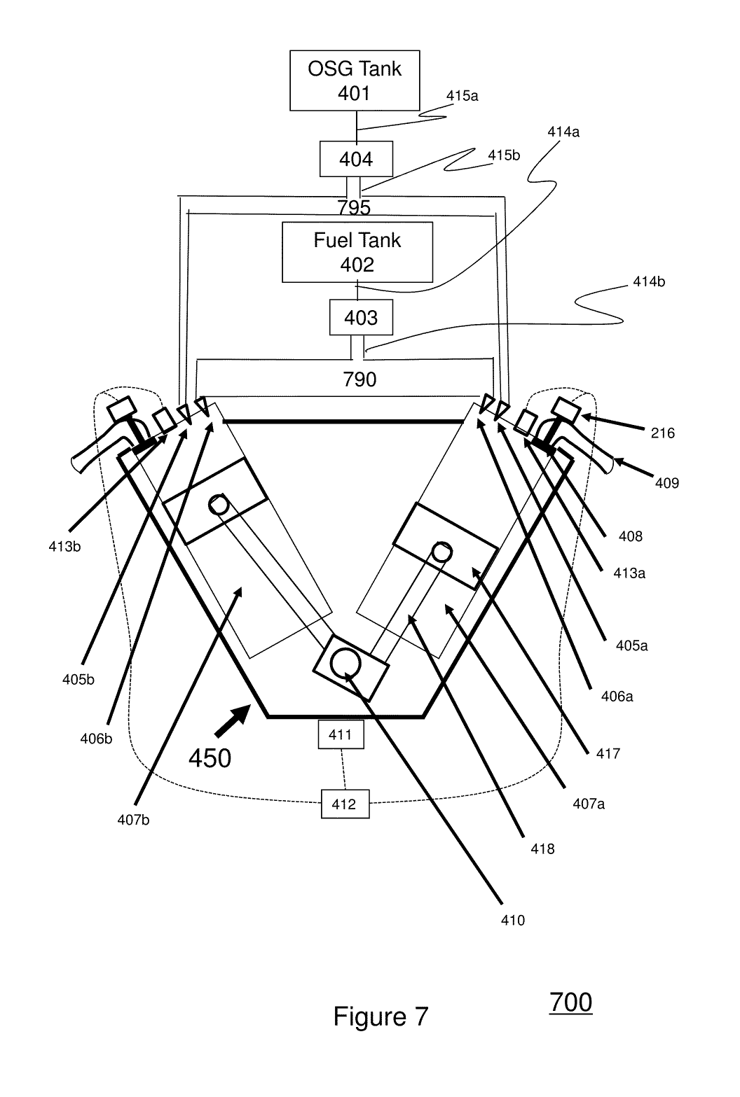

FIG. 7 illustrates a power generating system 700 including an engine 450, according to an exemplary aspect of the invention. The descriptions above with respect to the first through fourth embodiments are incorporated herein by reference.

In particular, FIG. 7 illustrates an exemplary schematic block diagram of a N-cylinder engine (e.g., N-cylinder CNG powered engine), where N is a positive integer, utilizing a source of OSG (e.g., compressed air) to mix with the fuel (e.g., CNG fuel) to promote combustion. FIG. 7 also illustrates an exemplary engine start system utilizing the properties of the OSG and fuel (e.g., CNG fuel), as well as replacement of the camshaft with an exhaust valve actuator (electrical, pneumatic or hydraulic) that can be used to control the opening and closing of the exhaust valve 408.

As illustrated in FIG. 7, the fuel (e.g., CNG) is routed from a fuel tank 402, to the fuel expansion valve 403 via a first fuel line 414a. The fuel expansion valve 403 reduces the pressure of the fuel and allows the second fuel line 414b to route the reduced pressure fuel to a fuel manifold 790 which is attached to a multiplicity of fuel injectors, one per cylinder, represented by fuel injectors 406a and 406b which correspond to cylinders 407a and 407b, respectively.

OSG is routed from a OSG tank 401 (e.g., high pressure OSG tank), to the OSG expansion valve 404 via a first OSG line 415a. The OSG expansion valve 404 reduces the pressure of the OSG and allows the second OSG line 415b to route the reduced pressure OSG to an OSG manifold 795 which is attached to a multiplicity of OSG injectors, one per cylinder, represented by OSG injector 405a and 405b, which correspond to cylinders 407a and 407b, respectively.

Igniters 413a and 413b are present in cylinders 407a and 407b to allow ignition of the OSG and fuel mixture in the appropriate cylinder(s) on command of the computerized controller 412.

Every other aspect of the operation of the power generating system 700 is identical to that described for the operation of power generating system 600 in FIG. 6. That is, operation of each of the individual cylinders of the N-cylinder combustion engine in power generating system 700 is managed by the computerized controller 412 as described above with respect to the power generating system 600.

In particular, the computerized controller 412 may also control the fuel injector 406, OSG injector 405 and igniter 413 in a manner discussed above with respect to FIGS. 2A-3C.

### Sixth Embodiment

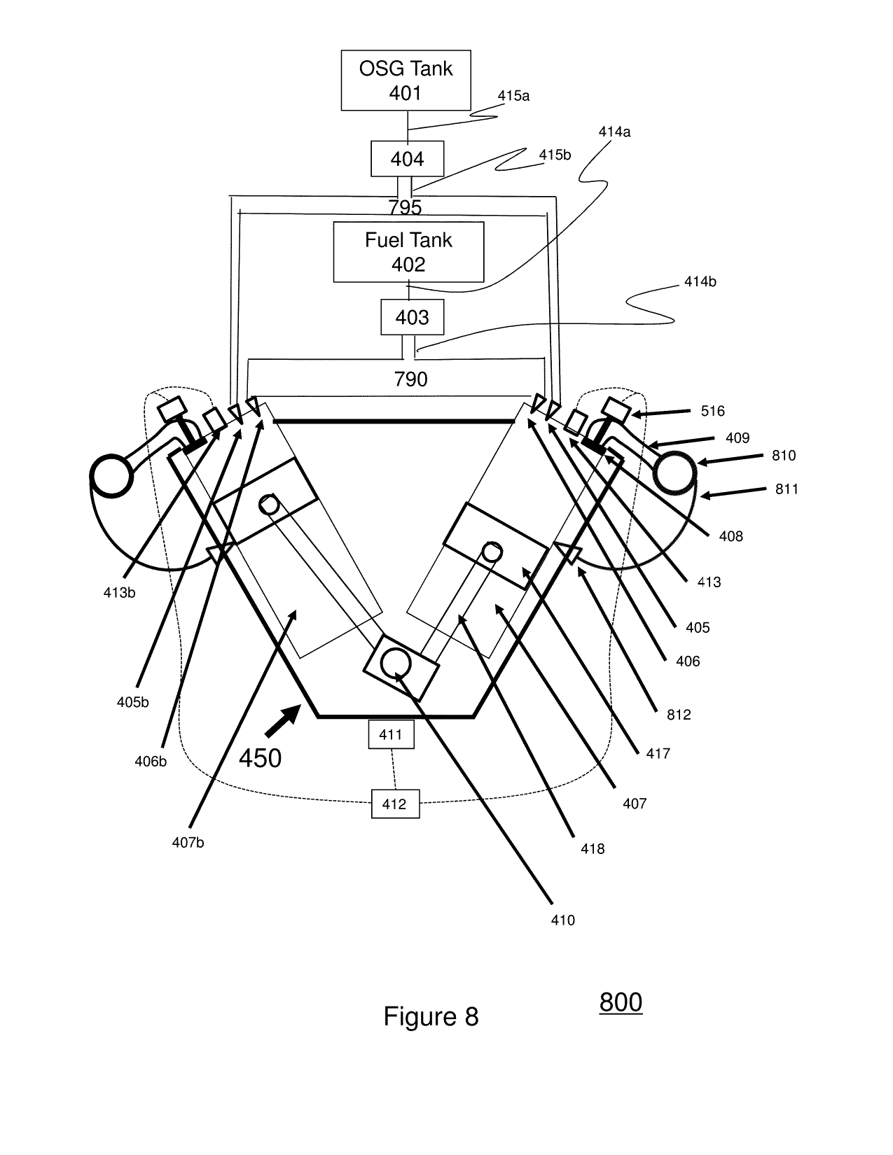

FIG. 8 illustrates a power generating system 800 including an engine 450, according to an exemplary aspect of the invention. The descriptions above with respect to the first through fifth embodiments are incorporated herein by reference.

In particular, FIG. 8 illustrates an exemplary schematic block diagram of a N-cylinder CNG powered engine, utilizing a source of OSG to mix with the CNG fuel to promote combustion. FIG. 8 also illustrates an exemplary engine start system utilizing the properties of the compressed OSG and CNG, as well as replacement of the camshaft with an exhaust valve actuator (electrical, pneumatic or hydraulic) that can be used to control the opening and closing of the exhaust valve.

As illustrated in FIG. 8, the fuel (e.g., CNG fuel) is routed from a fuel tank 402, to the fuel expansion valve 403 via a first fuel line 414a. The fuel expansion valve 403 reduces the pressure of the fuel and allows the second fuel line 414b to route the reduced pressure fuel to a fuel manifold 790 which is attached to a multiplicity of fuel injectors, one per cylinder, represented by fuel injector 406a and 406b which correspond to cylinder 407a and 407b, respectively.

OSG is routed from an OSG tank 401 (e.g., high pressure OSG tank), to the OSG expansion valve 404 via a first OSG line 415a. The OSG expansion valve 404 reduces the pressure of the OSG and allows the second OSG line 415b to route the reduced pressure OSG to an OSG manifold 795 which is attached to a multiplicity of OSG injectors, one per cylinder, represented by OSG injector 405a and 405b which correspond to cylinder 407a and 407b, respectively.

Igniters 413a and 413b are present in cylinders 407a and 407b to allow ignition of the OSG and fuel mixture in the appropriate cylinder(s) on command of the computerized controller 412.

As illustrated in FIG. 8, in the power generating system 800, the exhaust manifold 409 may be connected to a turbocharger 810 which pressurizes OSG through connecting line 811. The connecting line 811 is attached to a port 812 in the side of the cylinder 407. The port 407 is covered or uncovered by piston 417 to effectively open or close the port as the piston 417 cycles near the bottom of its travel in the cylinder 407. The pressurized OSG introduced into the cylinder 407 via the port 407 has the effect of flushing spent combustion product (e.g., combustion gases) out through exhaust valve 408 when it is opened by the controller 412. When the exhaust valve 408 is closed by the controller 412, the pressurized OSG introduced into the cylinder 407 via the port 407 has the effect of pressurizing the cylinder 407. This pressurization of the cylinder 407 reduces the amount of pressurized OSG that must be consumed from pressurized OSG tank 401, thereby extending the range of the engine before the pressurized OSG tank 401 must be replenished.

Every other aspect of the operation of the power generating system 800 is identical to that described for the operation of power generating system 700 in FIG. 7. That is, operation of each of the individual cylinders of the N-cylinder combustion engine in power generating system 800 is managed by the computerized controller 412 as described above with respect to the power generating system 700.

In particular, the computerized controller 412 may also control the fuel injector 406, OSG injector 405 and igniter 413 in a manner discussed above with respect to FIGS. 2A-3C.

### Seventh Embodiment

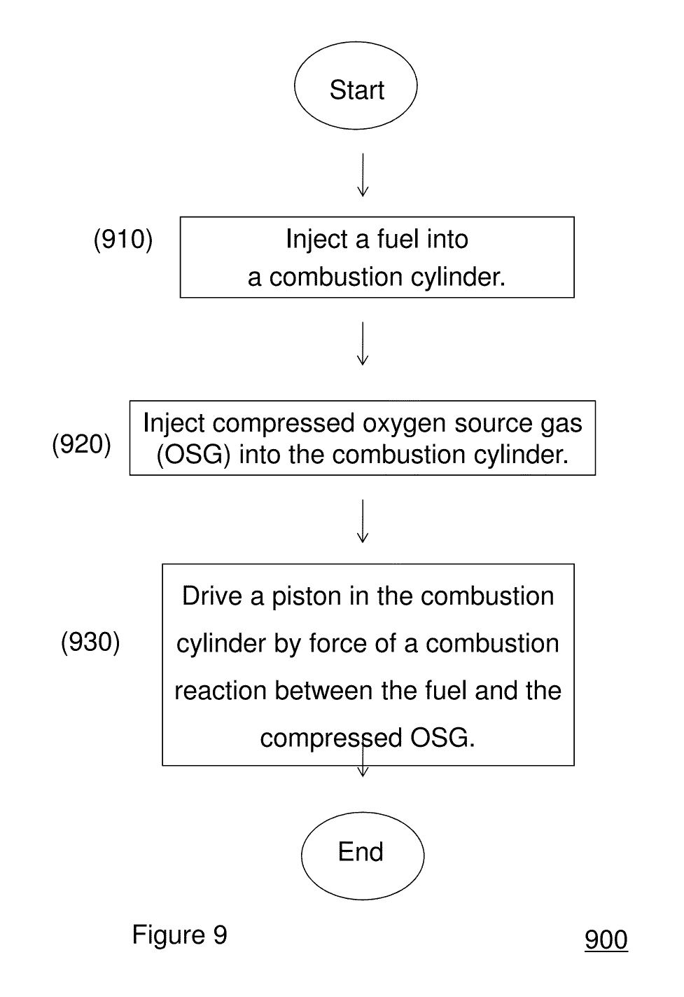

FIG. 9 illustrates a method 900 of generating power, according to another exemplary aspect of the present invention.

As illustrated in FIG. 9, the method 900 includes injecting (910) a fuel into a combustion cylinder, injecting (920) compressed OSG into the combustion cylinder, and driving (930) a piston by force of a combustion reaction between the fuel and the compressed OSG.

### Eighth Embodiment

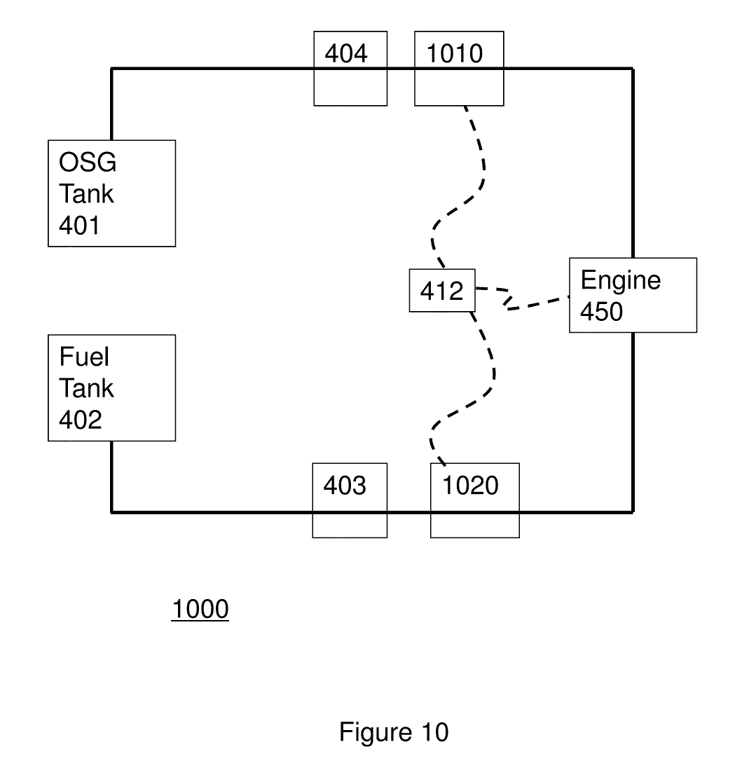

FIG. 10 illustrates a power generating system 1000, according to an exemplary aspect of the present invention.

In particular, FIG. 10 illustrates an exemplary schematic block diagram of a power generating system 1000 which may be used, for example, to power a vehicle (e.g., car, truck, boat, train, aircraft, etc.).

As illustrated in FIG. 10, the power generating system 1000 includes OSG tank 401, OSG expansion valve 404, fuel tank 402, fuel expansion valve 403, controller 412 and engine 450, as described above in the second through sixth embodiments.

In addition, the power generating system 1000 includes an OSG heating device 1010 (e.g., heat exchanger) which may be formed in the OSG line 415b and heats the OSG which has been expanded in the OSG expansion valve 404, and a fuel heating device 1020 (e.g., heat exchanger) which may be formed in the fuel line 414b and heats the fuel which has been expanded in the fuel expansion valve 403.

Expansion of the OSG and the fuel will reduce the temperature of the OSG and fuel, and the OSG heating device 1010 and the fuel heating device 1020 may be used to at least offset the reduction in temperature of the OSG and fuel caused by the expansion (e.g., return the OSG and fuel to ambient temperature). The OSG heating device 1010 and the fuel heating device 1020 may be also be used to increase the temperature of the OSG and fuel to a temperature which is greater than ambient temperature. Thus, for example, during the winter when the ambient temperature is very low, the OSG heating device 1010 and the fuel heating device 1020 may heat the OSG and fuel to a temperature which is greater than ambient temperature in order to improve a performance of the engine 450.

Further, the OSG heating device 1010 and the fuel heating device 1020 may include for example, an electric heater (e.g., electric heating coil). Alternatively, the OSG heating device 1010 and the fuel heating device 1020 may use heat generated by the operation of the engine 450 as a heat source for heating the OSG and fuel.

The OSG heating device 1010 and the fuel heating device 1020 may also be controlled by the controller 412 which may operate the OSG heating device 1010 and the fuel heating device 1020 so as to maximize the efficiency of the engine 450 (e.g., horsepower generated per unit of fuel) and/or to minimize the amount of pollutants in the combustion product.

### Ninth Embodiment

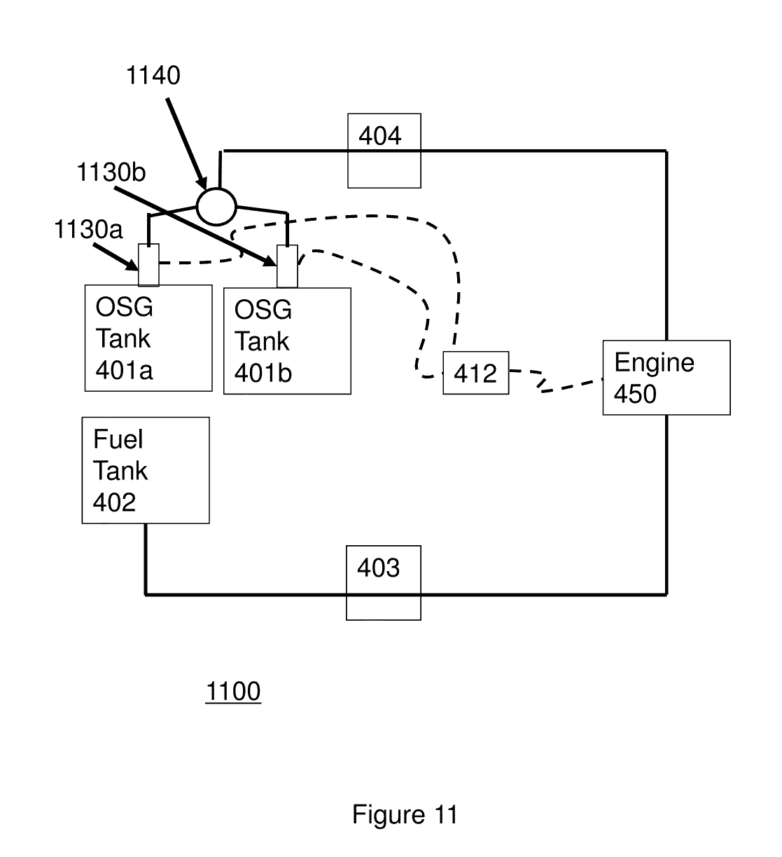

FIG. 11 illustrates a power generating system 1100, according to an exemplary aspect of the present invention.

In particular, FIG. 11 illustrates an exemplary schematic block diagram of a power generating system 1100 which may be used, for example, to power a vehicle (e.g., car, truck, boat, train, aircraft, etc.).

As illustrated in FIG. 11, the power generating system 110 includes an OSG expansion valve 404, fuel tank 402, fuel expansion valve 403, controller 412 and engine 450, as described above in the second through sixth embodiments. In addition, the power generating system 1100 includes first and second OSG tanks 401a and 401b which may store a first OSG and a second OSG, respectively (e.g., store a plurality of different gases), and a mixer unit 1140 which may mix the first and second OSGs. For example, the first OSG tank 401a may store compressed air and the second OSG tank 401b may store oxygen.

In addition, the power generating system 1100 may also include a first OSG supply valve 1130a for controlling a supply of the first OSG from the first OSG tank 401a, and a second OSG supply valve 1130b for controlling a supply of the second OSG from the second OSG tank 401b.

The first and second OSG supply valves 1130a and 1130b may be coupled to the controller 412 which may control the timing and amount of first and second OSG gases supplied from the first and second OSG tanks 401a, 401b, respectively.

For example, if the engine 450 is operating under a first condition (e.g., a first vehicle speed, first ambient temperature, first temperature of the engine 450, first composition of combustion product in exhaust manifold, etc.), the controller 412 may control the first and second OSG supply valves 1130a and 1130b to supply the first and second OSGs at a first ratio, and if the engine 450 is operating under a second condition different than the first condition (e.g., a second vehicle speed, second ambient temperature, second temperature of the engine 450, second composition of combustion product in exhaust manifold, etc.), the controller 412 may control the first and second OSG supply valves 1130a and 1130b to supply the first and second OSGs at a second ratio which is different from the first ratio.

### Tenth Embodiment

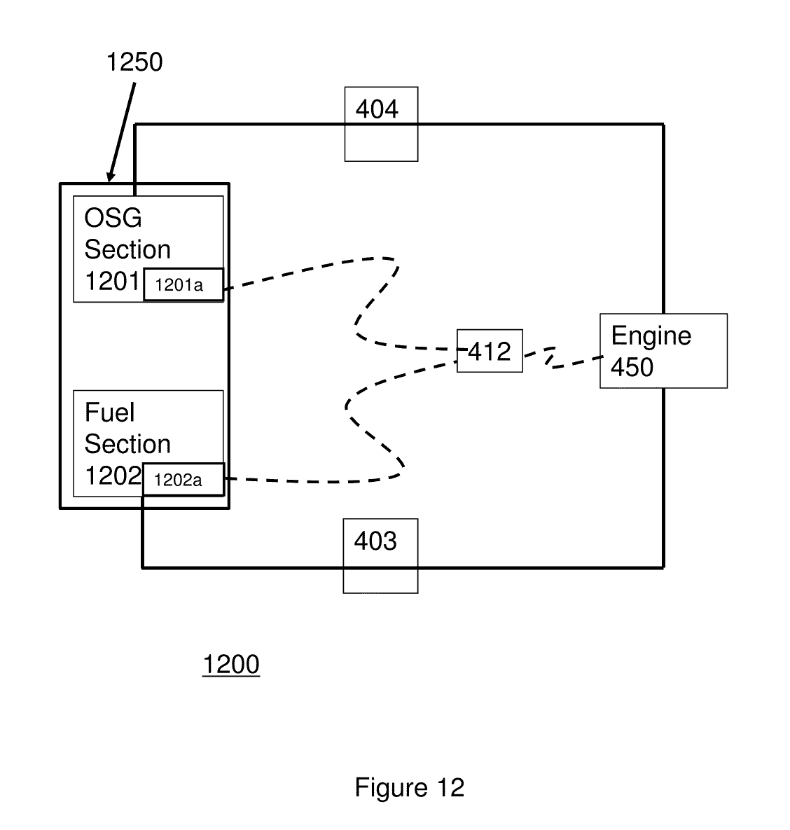

FIG. 12 illustrates a power generating system 1200, according to an exemplary aspect of the present invention.

In particular, FIG. 12 illustrates an exemplary schematic block diagram of a power generating system 1200 which may be used, for example, to power a vehicle (e.g., car, truck, boat, train, aircraft, etc.).

As illustrated in FIG. 12, the power generating system 1200 includes OSG expansion valve 404, fuel expansion valve 403, controller 412 and engine 450, as described above in the second through sixth embodiments. The power generating system 1200 also includes multipurpose tank for storing a plurality of different compressed gases. In particular, the multipurpose tank includes an OSG subtank 1201 for storing OSG, and a fuel subtank 1202 for storing compressed fuel.

In addition, the OSG subtank 1201 may include a sensor 1201a which is coupled to the controller 412 and may detect a condition in the OSG subtank 1201. For example, the sensor 1201a may detect an amount of OSG remaining in the OSG subtank 1201, a composition of the OSG (e.g., concentration of oxygen) in the OSG subtank 1201, etc.

Further, the fuel subtank 1202 may include a sensor 1202a which is coupled to the controller 412 and may detect a condition in the fuel subtank 1202. For example, the sensor 1202a may detect an amount of fuel remaining in the OSG subtank 1201, a composition of the fuel in the fuel subtank 1202, etc.

### Eleventh Embodiment

Referring to FIGS. 2A-12, another aspect of the present invention is directed to a computer program product which may include, for example, a computer readable storage medium (hereinafter, the “storage medium”) that may store computer readable program instructions (hereinafter, the “computer program” or “instructions”) for performing the features and functions of the present invention (e.g., engine 200, and systems 400, 500, 600, 700, 800, 1000, 1100 and 1200) and performing the method 900. That is, the storage medium may store the instructions thereon for causing a processing device (e.g., computer, instruction execution device, computing device, computer processor, central processing unit (CPU), microprocessor, etc.) to perform a feature or function of the present invention.

The storage medium can be a tangible device that can retain and store the instructions for execution by the processing device. The storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

The storage medium, as used herein, should not be construed as merely being a “transitory signal” such as a radio wave or other freely propagating electromagnetic wave, an electromagnetic wave propagating through a waveguide or other transmission media (e.g., light pulses passing through a fiber-optic cable), or an electrical signal transmitted through a wire.

The processing device can access the instructions on the storage medium. Alternatively, the processing device can access (e.g., download) the instructions from an external computer or external storage device via a network such as the Internet, a local area network, a wide area network and/or a wireless network.

The network may include, for example, copper transmission cables, optical transmission fibers, wireless transmission, routers, firewalls, switches, gateway computers and/or edge servers. For example, the processing device may include a network adapter card or network interface which receives the instructions from the network and forwards the instructions to the storage medium within the processing device which stores the instructions.

The instructions for performing the features and functions of the present invention may include, for example, assembler instructions, instruction-set-architecture (ISA) instructions, machine instructions, machine dependent instructions, microcode, firmware instructions, state-setting data, or either source code or object code written in one or more programming languages (or combination of programming languages), including an object oriented programming language such as Java, Smalltalk, C++ or the like, and conventional procedural programming languages, such as the “C” programming language or similar programming languages.

The instructions may execute entirely on the processing device (e.g., a user's computer), partly on the processing device, as a stand-alone software package, partly on the processing device and partly on a remote computer or entirely on the remote computer or a server. For example, the instructions may execute on a remote computer which is connected to the processing device (e.g., user's computer) through a network such as a local area network (LAN) or a wide area network (WAN), or may execute on an external computer which is connected to the processing device through the Internet using an Internet Service Provider.

The processing device may include, for example, electronic circuitry including, for example, programmable logic circuitry, field-programmable gate arrays (FPGA), or programmable logic arrays (PLA) that may execute the instructions by utilizing state information of the instructions to personalize the electronic circuitry, in order to perform a feature or function of the present invention.

It should be noted that the features and functions of the present invention which are described above with reference to FIGS. 2A-12 may be implemented by the processing device executing the instructions. That is, each block of the flowchart illustrations and/or block diagrams, and combinations of blocks in the flowchart illustrations and/or block diagrams, can be implemented by processing device executing the instructions.

The instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

That is, the instructions may be executed by a processing device to cause a series of operational steps to be performed by the processing device to produce a computer-implemented process, so that the executed instructions implement the features/functions/acts described above with respect to the flowchart and/or block diagram block or blocks of FIGS. 2A-12.

Thus, the flowchart and block diagrams in the FIGS. 2A-12 illustrate not only a method, system, apparatus or device, but also illustrate the architecture, functionality, and operation of the processing device executing the instructions. In this regard, each block in the flowchart or block diagrams may represent a module, segment, or portion of the instructions, which comprises one or more executable instructions for implementing the specified logical function(s). In some alternative implementations, the features or functions in the block may occur out of the order noted in the figures.

For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

With its unique and novel features, the present invention may provide a combustion engine which is more efficient and effective than conventional combustion engines.

While the invention has been described in terms of one or more exemplary embodiments, those skilled in the art will recognize that the invention can be practiced with modification within the spirit and scope of the appended claims. Specifically, one of ordinary skill in the art will understand that the drawings herein are meant to be illustrative, and the design of the inventive method and system is not limited to that disclosed herein but may be modified within the spirit and scope of the present invention.

Further, Applicant's intent is to encompass the equivalents of all claim elements, and no amendment to any claim the present application should be construed as a disclaimer of any interest in or right to an equivalent of any element or feature of the amended claim.

What is claimed is:

1. A combustion engine, comprising:
a combustion cylinder;
a fuel injector for injecting a fuel into the combustion cylinder;
an oxygen source gas (OSG) injector for injecting compressed OSG into the combustion cylinder; and
a piston which is formed in the combustion cylinder and driven by force of a combustion reaction between the fuel and the compressed OSG.

2. The combustion engine of claim 1, wherein the OSG injector comprises a variable flow rate valve which is connected to a wall of the combustion cylinder.

3. The combustion engine of claim 1, wherein the OSG injector continuously decreases a flow rate of the compressed OSG into the combustion chamber from a time when the piston is near an end of an upstroke to a time of a spark to initiate the combustion reaction between the fuel and the compressed OSG.

4. The combustion engine of claim 1, wherein the OSG injector continuously decreases a flow rate of the compressed OSG into the combustion chamber from a time when the piston is near an end of an upstroke to a time when the piston begins a next upstroke.

5. The combustion engine of claim 1, wherein the OSG injector gradually decreases a flow rate of the compressed OSG into the combustion chamber from a time when the piston is near an end of an upstroke to a time when the piston begins a next upstroke.

6. The combustion engine of claim 1, wherein the OSG injector injects OSG into the combustion chamber at a first flow rate at a time when the piston is near an end of an upstroke, and injects OSG into the combustion chamber at a second flow rate at a time when the piston is begins a next upstroke, the second flow rate being greater than zero and less than the first flow rate.

7. The combustion engine of claim 1, wherein the OSG injector continuously injects OSG to into the combustion cylinder during an upstroke and a downstroke of the combustion engine.

8. The combustion engine of claim 1, wherein the fuel comprises at least one of compressed combustible fuel, compressed natural gas (CNG), gasoline, an alcohol, diesel fuel and hydrogen.

9. The combustion engine of claim 1, further comprising:
an exhaust valve connected to the combustion cylinder and exhausting a combustion product of the combustion reaction from the combustion cylinder;
an exhaust line for transporting the combustion product away from the combustion cylinder; and
a sensor which is formed in the exhaust line and detects a composition of the combustion product,
wherein the OSG injector varies a flow rate of OSG into the combustion cylinder based on the composition of the combustion product.

10. A power generation system, comprising:
a fuel tank for storing a fuel;
a pressurized oxygen source gas (OSG) tank for storing compressed OSG; and
a combustion engine, comprising:
a combustion cylinder;
a fuel injector for injecting the fuel into the combustion cylinder;
an OSG injector for injecting the compressed OSG into the combustion cylinder; and
a piston which is formed in the combustion cylinder and driven by force of a combustion reaction between the fuel and the compressed OSG.

11. The power generation system of claim 10, further comprising:
a controller which controls the OSG injector to vary a flow rate of the OSG injected by the OSG injector.

12. The power generation system of claim 11, wherein the OSG tank comprises a plurality of storage tanks including a first storage tank storing a first compressed gas and a second storage tank storing a second compressed gas which is different from the first compressed gas.

13. The power generation system of claim 12, further comprising:
a mixer unit which mixes the first and second compressed gases and outputs the OSG to be supplied to the combustion engine; and
first and second valves for controlling a flow rate of the first and second compressed gases from the first and second storage tanks,
wherein the controller controls the first and second valves so as to control a ratio of the first and second compressed gases in the OSG.

14. The power generation system of claim 10, further comprising:
an OSG line for transporting the compressed OSG from the pressurized OSG tank to the combustion engine; and
an OSG expansion valve which expands the compressed OSG from the OSG tank and reduces a pressure of the compressed OSG, such that a pressure of the OSG injected into the combustion chamber is less than a pressure of the compressed OSG stored in the OSG tank.

15. The power generation system of claim 14, further comprising:
an OSG heating device formed in the OSG line between the OSG expansion valve and the combustion engine, for heating the OSG such that a temperature of the OSG injected into the combustion chamber is greater than a temperature of the expanded OSG exiting the OSG expansion valve.

16. The power generation system of claim 14, further comprising:
an OSG manifold formed on the combustion engine and delivering the OSG from the OSG line to the OSG injector.

17. The power generation system of claim 11, further comprising:
a crankshaft which is driven by the piston; and
a crankshaft position sensor which senses a position of the crankshaft,
wherein the controller controls the fuel injector and the OSG injector based on the sensed position of the crankshaft.

18. The power generation system of claim 17, further comprising:
a camshaft which is driven by the crankshaft,
wherein the combustion engine further comprises an exhaust valve for exhausting a combustion product from the combustion cylinder, the exhaust valve being actuated by the camshaft.

19. The power generation system of claim 9, wherein the power generation system comprises a vehicle power generation system, and the controller comprises an electronic control unit (ECU) for the vehicle.

20. A method of generating power, comprising:
injecting a fuel into a combustion cylinder;
injecting compressed OSG into the combustion cylinder; and
driving a piston in the combustion cylinder by force of a combustion reaction between the fuel and the compressed OSG.
